(19) United States
(12) Patent Application Publication
(10) Pub. No.: US 2007/0187963 A1
(43) Pub. Date: Aug. 16, 2007

(54) COMBINATION GRILL MITT AND GRILL TOOL

(75) Inventors: Timothy Repp, Pleasant Valley, CT (US); Thomas Murphy, Arlington, TX (US)

Correspondence Address: DANIEL V. THOMPSON, 9330 LBJ FWY., SUITE 1185, DALLAS, TX, 75243, US

(73) Assignee: CLEVER EDGE, INC., Collinsville, CT (US)

(21) Appl. No.: 11/307,603

(22) Filed: Feb. 14, 2006

(51) Int. Cl. A47J 43/28

(52) U.S. Cl. 294/3

(57) ABSTRACT

A combination grill mitt and grill tool has a grill mitt and a grill tool connected to the grill mitt. The grill tool may be selected from the group of spatula, tongs and fork.

### BACKGROUND OF THE INVENTION

Hand-held tools for moving food on or off barbecue grills have been developed in many convenient and efficient forms. A widely available form of barbecue grill tool has a hand grip, a relatively long intermediate section, and a spatula-like, flat, wide, rectangular head section. Other grill tools have two opposing parts that function like tongs. Fork-like grill tools are also known.

The major disadvantage of prior art barbecue grill tools is that they do not protect the user's hand from the intense heat that charcoal and gas grills generate. Consequently, the user risks burn injuries to his or her hand and forearm. Users also risk singeing the hair off their knuckles and hand. Another disadvantage is that the heat limits the amount of time the user can tolerate working at the grill, resulting in incomplete cooking or overcooking, due to having to break up tasks into multiple attempts. Tools with longer hand grips enable the user to grasp the hand grip farther away from the heat, but at the sacrifice of maneuverability, dexterity and leverage.

A recent development in the art of cooking tools generally involves cooking mitts formed of silicone rubber, for example, the Dexas Silicone Oven Mitts by Dexas International of Coppell, Tex. USA. These mitts are effective in protecting hands from hot surfaces, but they are general purpose and not specific to barbecue grilling.

### SUMMARY OF THE INVENTION

A combination grill mitt and grill tool has a grill mitt and a grill tool connected to the grill mitt. The grill tool may selected from the group of spatula, tongs and fork.

### BRIEF DESCRIPTION OF THE DRAWINGS

A more complete understanding of the invention and its advantages will be apparent from a review of the Detailed Description in conjunction with the following Drawings, in which:

FIG. 1 is a perspective view of one embodiment of the invention.

FIG. 2 is a top view of the embodiment of FIG. 1.

FIG. 3 is a partial side view of the embodiment of FIGS. 1 and 2.

FIG. 4 is a partial side view showing the invention in operation.

FIG. 5 is a sectional view taken along lines 5-5 of FIG. 3.

FIG. 6 is a sectional view taken along lines 6-6 of FIG. 5.

FIG. 7 is a sectional view taken along lines 7-7 of FIG. 3.

### DETAILED DESCRIPTION

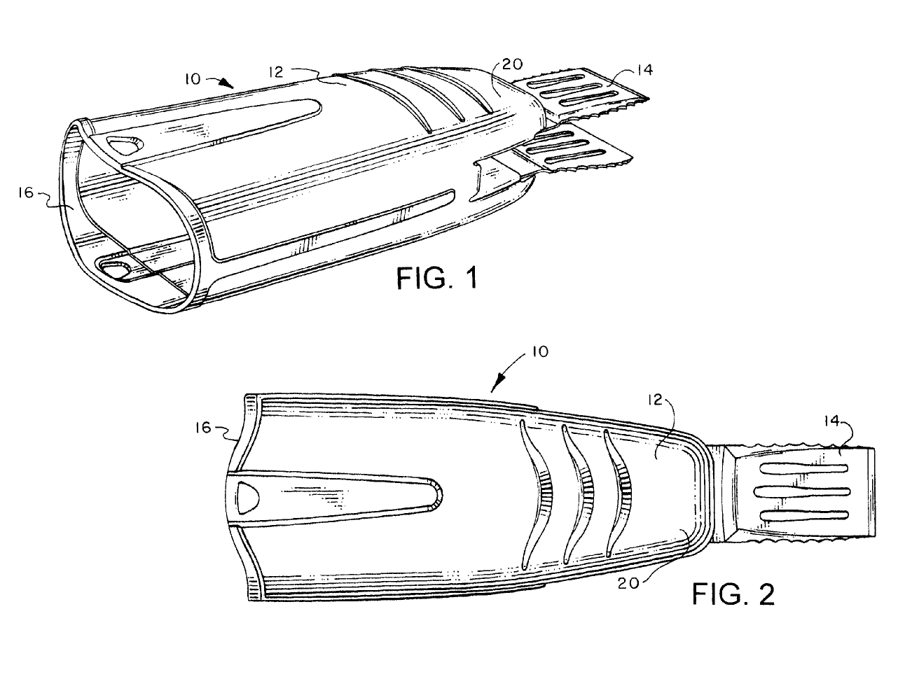

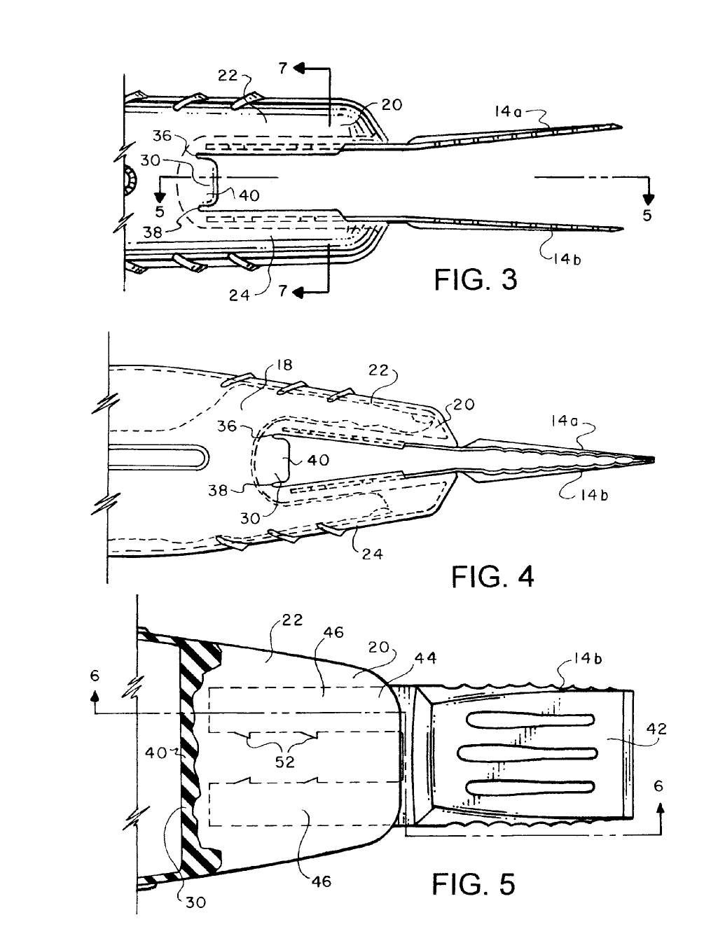

Referring to FIGS. 1-7, where like numerals indicate like and corresponding elements, a combination grill mitt and grill tool 10 includes a grill mitt 12 and a grill tool 14. Preferably the grill tool 14 is selected from the group of spatula, tongs and fork, although other grill tools such as brushes, spoons, and the like may be chosen. In the illustrated embodiment, the grill tool includes two spatulas 14a,14b with slightly concave working sections, such that they function as tongs when closed about a food item or a single one may be used as a conventional spatula.

Grill mitt 12 is integrally formed of flexible silicone rubber of the type having a working temperature of up to 500° F. Grill mitt 12 is open at back end 16 to receive a hand 18 (FIG. 4) of a user and closed at front end 20.

The front end 20 of the grill mitt 12 is formed of identically-shaped and sized upper and lower pocket cavities 22,24 defined by upper and lower pocket walls 26,28, such that the grill mitt 12 may be worn equally-effectively with the thumb and fingers in either of the upper and lower pocket cavities 22,24 and on either the left or right hand of a user.

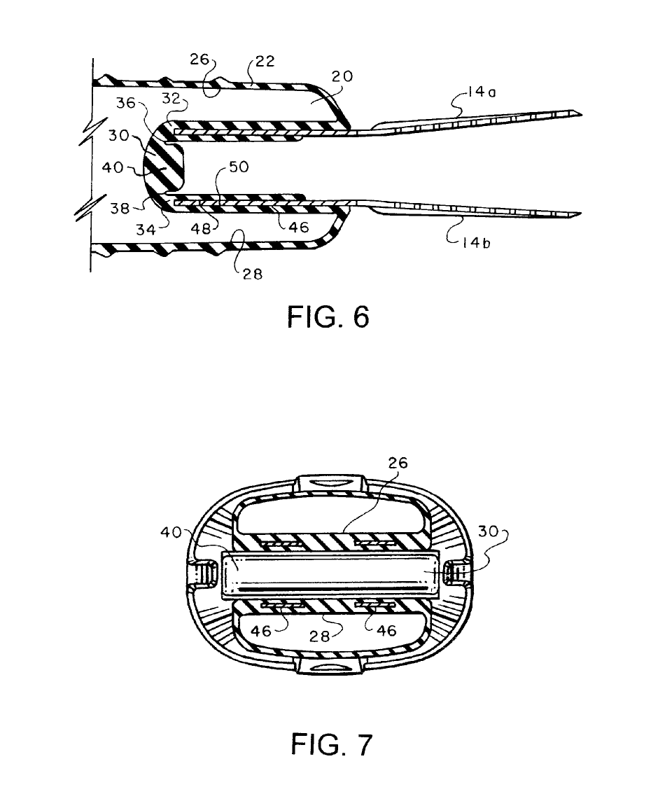

The upper and lower pocket cavities 22,24 are joined by a hinge section 30 at inner, back portions 32,34 (FIG. 6) of the pocket cavities 22,24.

The hinge section 30 includes at least one hinge to permit relative movement of the pocket cavities 22,24. In the illustrated embodiment two hinges including upper and lower hinges 36,38 are joined to one another by a spacer 40. One skilled in the art will recognize that a simpler but less effective form of hinge section 30 may include only one centrally located hinge or even merely a flexible wall joining the upper and lower pocket walls 26,28. The key functional requirement is that the extreme ends of the pocket cavities be permitted to move close to one another while maintaining a spaced-apart configuration at the hinge section, such that items may be gripped by the mitt and force may be applied by the working portion(s) of the tool.

In the illustrated embodiment, the spacer 40 is relatively thick and stiff relative to the hinges to readily maintain spacing between the hinges during relative motion of the pocket cavities towards one another and to provide a fulcrum against which force may be applied by the tool, as best shown in FIG. 4.

The grill tool 14, in whichever of the several possible types provided, is formed of metal. In the illustrated embodiment, the grill tool 14b has a working end 42 and terminates at a shank 44 opposite the working end 42. The shank 44 has at least one, and preferably two, long, rectangular, flat portions 46 adapted and arranged to be received into a shank cavity 48 (FIG. 6) formed by shank cavity walls 50 in the grill mitt 12. As illustrated, where the tool 14 includes identical spatula 14a and 14b, both pocket cavities 22,24 include shank cavities formed in similar fashion.

Depending on the tolerances and fit of the tool shank 44 and shank cavity 48, it may be desirable to arrange and adapt the flat portion 46 of the shank 44 to include barbs 52 engaged with at least one shank cavity wall 50 for inhibiting removal of the tool from the mitt during use while cooking. Likewise, the barbs 52 may be adapted and arranged to permit removal of the tool 14 from the grill mitt 12 for cleaning upon external manipulation of the shank cavity walls 50. In one example of the invention, the tool 14 may be removed by squeezing the shank cavity walls externally while pulling the tool away from the mitt, a manipulation that does not occur during normal cooking use.

In operation, the combination grill mitt and grill tool of the present invention protects the user's hand from the intense radiant and convective heat generated by charcoal and gas grills. It eliminates singeing the hair on the user's knuckles and hand, as it greatly reduces the potential for burning the user's hand and forearm by contacting hot surfaces. The invention allows the user adequate time to comfortably and thoroughly cook food over the entire grill surface. The user is able to apply force to the tool closer to the head section so that more force can be exerted on the tool. The invention not only protects the user's hand and forearm from heat and sparks, but also eliminates the need to purchase a separate pair of insulated gloves or mittens or waste time hunting for one. In the embodiment illustrated, the functions of spatula, tongs and glove are performed in one structure.

What is claimed is:

1. A combination grill mitt and grill tool, comprising:
a grill mitt; and
a grill tool connected to the grill mitt.

2. The combination of claim 1 with the grill tool selected from the group of spatula, tongs and fork.

3. The combination of claim 2 with the grill tool comprising two spatulas, such that they function as tongs when closed about a food item.

4. The combination of claim 1 with the grill mitt being integrally formed of flexible silicone rubber, and being open at a back end to receive a hand of a user and closed at a front end.

5. The combination of claim 4 with the front end of the grill mitt being formed of identically-shaped and sized upper and lower pocket cavities defined by pocket walls, such that the grill mitt may be worn equally-effectively with the thumb and fingers in either of the upper and lower pocket cavities and on either the left or right hand of a user.

6. The combination of claim 5 with the upper and lower pocket cavities being joined by a hinge section at inner, back portions of the pocket cavities.

7. The combination of claim 6 with at least one hinge permitting relative motion of the upper and lower pocket cavities.

8. The combination of claim 7 with two hinges, being spaced-apart upper and lower hinges.

9. A combination grill mitt and grill tool, comprising:
a grill mitt being integrally formed of flexible silicone rubber, and being open at a back end to receive a hand of a user and closed at a front end;
the front end of the grill mitt being formed of identically-shaped and sized upper and lower pocket cavities defined by pocket walls, such that the grill mitt may be worn equally-effectively with the thumb and fingers in either of the upper and lower pocket cavities and on either the left or right hand of a user;
the upper and lower pocket cavities being joined by a hinge section at inner, back portions of the pocket cavities;
the hinge section including upper and lower hinges joined to one another by a spacer;
the spacer being stiff relative to the hinges to maintain spacing between the hinges during relative motion of the pocket cavities towards one another; and
a grill tool connected to the grill mitt.

10. A combination grill mitt and grill tool, comprising:
a grill mitt;
a grill tool connected to the grill mitt; and
the grill tool formed of metal, and having a working end and terminating at a shank opposite the working end.

11. The combination of claim 10 with the shank adapted and arranged to be received into a shank cavity formed by shank cavity walls in the grill mitt.

12. The combination of claim 11 with the shank having at least one long, rectangular, flat portion received into the shank cavity.

13. The combination of claim 12 with the flat portion of the shank including barbs engaged with at least one shank cavity wall for inhibiting removal of the tool from the grill mitt.

14. The combination of claim 11 with the shank being adapted and arranged to permit removal of the tool from the grill mitt for cleaning upon external manipulation of the shank cavity walls.

15. A combination grill mitt and grill tool, comprising:
a grill mitt;
a grill tool connected to the grill mitt;
the grill tool formed of metal, and having a working end and terminating at a shank opposite the working end;
the shank having at least one long, rectangular, flat portion adapted and arranged to be received into a shank cavity formed by shank cavity walls in the grill mitt;
the flat portion of the shank including barbs engaged with at least one shank cavity wall for inhibiting removal of the tool from the grill mitt; and
the barbs being adapted and arranged to permit removal of the tool from the grill mitt for cleaning upon external manipulation of the shank cavity walls.

16. The combination of claim 15 with the grill tool selected from the group of spatula, tongs and fork.

17. The combination of claim 16 with the grill tool comprising two spatulas, such that they function as tongs when closed about a food item.

18. A combination grill mitt and grill tool, comprising:
a grill mitt being integrally formed of flexible silicone rubber, and being open at a back end to receive a hand of a user and closed at a front end;
the front end of the grill mitt being formed of identically-shaped and sized upper and lower pocket cavities defined by pocket walls, such that the grill mitt may be worn equally-effectively with the thumb and fingers in either of the upper and lower pocket cavities and on either the left or right hand of a user; the upper and lower pocket cavities being joined by a hinge section at inner, back portions of the pocket cavities;
the hinge section including upper and lower hinges joined to one another by a spacer; the spacer being stiff relative to the hinges to maintain spacing between the hinges during relative motion of the pocket cavities towards one another;
a grill tool connected to the grill mitt;
the grill tool formed of metal, and having a working end and terminating at a shank opposite the working end;
the shank having at least one long, rectangular, flat portion adapted and arranged to be received into a shank cavity formed by shank cavity walls in the grill mitt;
the flat portion of the shank including barbs engaged with at least one shank cavity wall for inhibiting removal of the tool from the grill mitt; and
the barbs being adapted and arranged to permit removal of the tool from the grill mitt for cleaning upon external manipulation of the shank cavity walls.

19. The combination of claim 18 with the grill tool selected from the group of spatula, tongs and fork.

20. The combination of claim 19 with the grill tool comprising two spatulas with slightly concave working sections, such that they function as tongs when closed about a food item.
